(19) United States
(12) Patent Application Publication
(10) Pub. No.: US 2016/0224674 A1
(43) Pub. Date: Aug. 4, 2016

(54) DYNAMIC ENTITY RENDERING FRAMEWORK

(71) Applicant: BANK OF AMERICA CORPORATION, CHARLOTTE, NC (US)

(72) Inventors: Jeffrey L. Miller, Charlotte, NC (US); Henry Victor Montgerard, Matthews, NC (US); Mark Robert Kendall, Charlotte, NC (US)

(21) Appl. No.: 14/613,034

(22) Filed: Feb. 3, 2015

(51) Int. Cl. G06F 17/30

(52) U.S. Cl. CPC G06F 17/30867

(57) ABSTRACT

Embodiments of the present invention are directed to systems, apparatuses, methods, and/or computer program products for viewing entity profiles of related entities. Entity profiles provide a user (e.g., an associate of a financial institution) with detailed views of information associated with entities, entity relationships with other entities, and entity relationships with the financial institution. The system of the present invention generates different views of entity profiles based on one or more predetermined attributes, which are user-configurable business rules for evaluating, controlling, and/or managing an entity and its relationship with the financial institution. In this way, the present invention is configured to present information associated with entities.

### FIELD

In general, embodiments of the invention relate to methods, systems, apparatuses, and computer program products for establishing relationships between one or more entities.

### BACKGROUND

Each year, a number of entities become customers (including vendors, and/or third parties) of a financial institution. These entities, however, may be associated with one or more other entities that are existing customers of the financial institution. For example, Entity A, a new customer of Bank A, may have been acquired by Entity B, who is an existing customer of Bank A. Therefore, a need exists for a system that determines relationships between entities that have become new customers of the financial institution and entities that are current customers of the financial institution.

Furthermore, a user (e.g., an agent or an associate of the financial institution) may desire to view relationships between entities in a variety of ways. For example, a user may wish to view a legal hierarchal structure of related entities, view a exposure-based hierarchal structure of related entities that is specific to the financial institution, or the like for analysis purposes. Therefore, a need exists for a system that enables a user to hierarchically view relationships between entities.

Lastly, as entities become customers of the financial institution, entity data (e.g., data associated with each entity) is onboarded to a data platform of the financial institution for classification of the entity. However, as entities are purchased, acquired, sold, or change (due to Mergers and Acquisitions (M&A) activity, for example), entity data associated with each affected entity may change. For example, determined relationships between entities or relationships between entities and the financial institution may require updating and/or maintenance. Therefore, a need exists for a system that routinely detects changes in entity relationships and recommends actions to be taken to update entity data accordingly.

### BRIEF SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The present invention is directed to systems, apparatuses, methods, and/or computer program products for viewing entity profiles of related entities. Entity profiles provide a user (e.g., an associate of a financial institution) with detailed views of information associated with entities, entity relationships with other entities, and entity relationships with the financial institution. The system of the present invention generates different views of entity profiles based on one or more predetermined attributes, which are user-configurable business rules for evaluating, controlling, and/or managing an entity and its relationship with the financial institution. In this way, the present invention is configured to present information associated with entities.

In some embodiments, a system for electronically viewing an entity profile based on one or more attributes is provided. The system comprises: at least one non-transitory electronic storage device; at least one processor; and at least one module stored in said storage device and comprising instruction code that is executable by the at least one processor and configured to cause said at least one processor to: receive entity data of an entity from a network of distributed servers; filter the received entity data based on a set of one or more predetermined attributes, thereby resulting in filtered entity data; generate an entity profile using the filtered entity data; and initiate presentation of the entity profile to a user.

In some embodiments, the set of one or more predetermined attributes are business rules associated with at least one of a Legal, Exposure, Engage, Manage, and Spend hierarchal view.

In some embodiments, the module is further configured to cause a processor to: receive at least one of updated entity data and one or more updated predetermined attributes; update the generated entity profile in real time using at least one of the updated entity data and one or more updated predetermined attributes, thereby generating an updated entity profile; and initiate presentation of the undated entity profile to the user.

In some embodiments, the entity profile comprises entity data of at least one other entity that is related to the entity.

In some embodiments, the module is further configured to cause a processor to: receive a request from a user to view an entity profile; and generate the entity profile in response to receiving the request.

In some embodiments, the module is further configured to cause a processor to: generate a report of the entity profile, wherein the report comprises at least one of a message, a notification, an email, and an alert; and transmit the report to the user.

In some embodiments, entity data comprises at least one of account information, contact information, and company information.

In some embodiments, a computer program product for electronically viewing an entity profile based on one or more attributes is provided. The computer program product comprising a non-transitory computer-readable medium comprising instruction code configured to cause an apparatus to: receive entity data of an entity from a network of distributed servers; filter the received entity data based on a set of one or more predetermined attributes, thereby resulting in filtered entity data; generate an entity profile using the filtered entity data; and initiate presentation of the entity profile to a user.

In some embodiments, the non-transitory computer-readable medium comprises instruction code configured to cause an apparatus to: receive at least one of updated entity data and one or more updated predetermined attributes; update the generated entity profile in real time using at least one of the updated entity data and one or more updated predetermined attributes, thereby generating an updated entity profile; and initiate presentation of the undated entity profile to the user.

In some embodiments, the entity profile comprises entity data of at least one other entity that is related to the entity.

In some embodiments, the non-transitory computer-readable medium comprises instruction code configured to cause an apparatus to: receive a request from a user to view an entity profile; and generate the entity profile in response to receiving the request.

In some embodiments, the non-transitory computer-readable medium comprises instruction code configured to cause an apparatus to generate a report of the entity profile, wherein the report comprises at least one of a message, a notification, an email, and an alert; and transmit the report to the user.

In some embodiments, a computer implemented method for electronically determining that a relationship exists between two entities is provided. The method comprises: receiving, by a computing device processor, entity data of an entity from a network of distributed servers; filtering, by a computing device processor, the received entity data based on a set of one or more predetermined attributes, thereby resulting in filtered entity data; generating, by a computing device processor, an entity profile using the filtered entity data; and initiating, by a computing device processor, presentation of the entity profile to a user.

In some embodiments, the method further comprises: receiving, by a computing device processor, at least one of updated entity data and one or more updated predetermined attributes; updating, by a computing device processor, the generated entity profile in real time using at least one of the updated entity data and one or more updated predetermined attributes, thereby generating an updated entity profile; and initiating, by a computing device processor, presentation of the undated entity profile to the user.

In some embodiments, the method further comprises: receiving, by a computing device processor, a request from a user to view an entity profile; and generating, by a computing device processor, the entity profile in response to receiving the request.

In some embodiments, the method further comprises: generating, by a computing device processor, a report of the entity profile, wherein the report comprises at least one of a message, a notification, an email, and an alert; and transmitting, by a computing device processor, the report to the user.

Clearly, the present invention provides many benefits. For example, the present invention enables the financial institution to customize views of entity profiles based on the predetermined attributes. This allows the financial institution to better manage its relationships with entities, as well as identify new opportunities by which the financial institution may engage entities. In this way, the present invention increases awareness of entity relationships.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is an exemplary system environment for executing the present invention as described herein, in accordance with embodiments of the invention;

FIG. 2 is an exemplary process flow diagram illustrating a process flow for identifying a relationship between two entities based on an analysis of entity data, in accordance with embodiments of the invention;

FIG. 3 is an exemplary process flow diagram illustrating a process flow for hierarchically viewing an entity profile, in accordance with embodiments of the invention;

FIG. 4 is an exemplary process flow diagram illustrating a process flow for identifying impacts based on changes in entity data, in accordance with embodiments of the invention; and

FIG. 5 illustrates exemplary user interfaces of two different system-generated views, in accordance with embodiments of the invention.

FIG. 6 illustrates a representation of the target state of the framework, in accordance with embodiments of the invention.

FIG. 7 illustrates an exemplary a high level process flow for master data management based on the target state of the framework, in accordance with embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

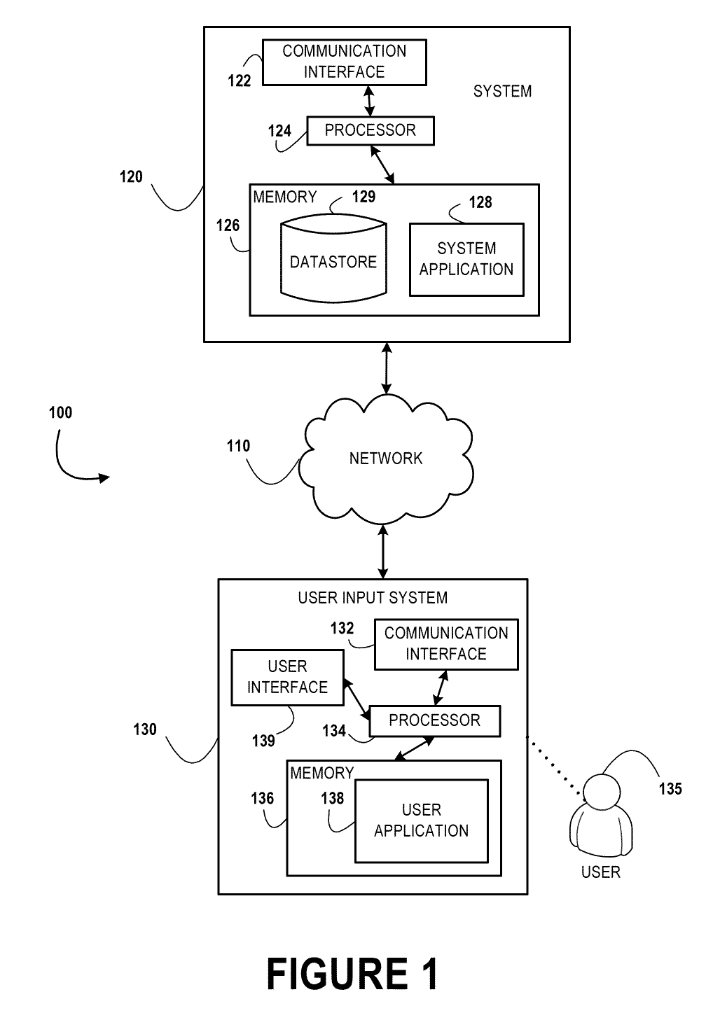

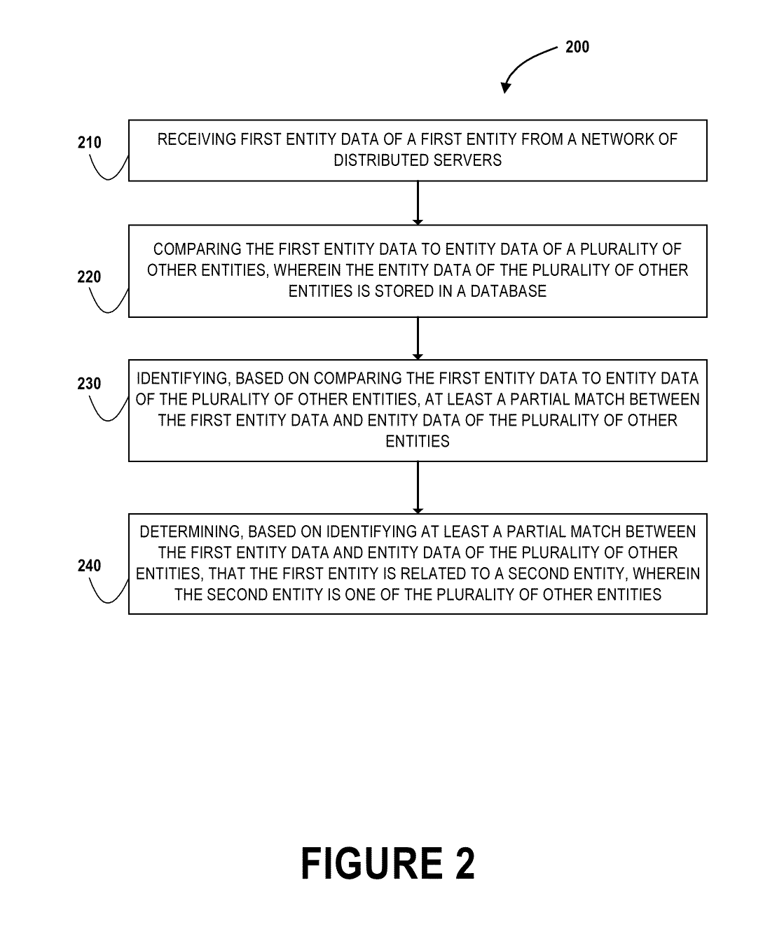

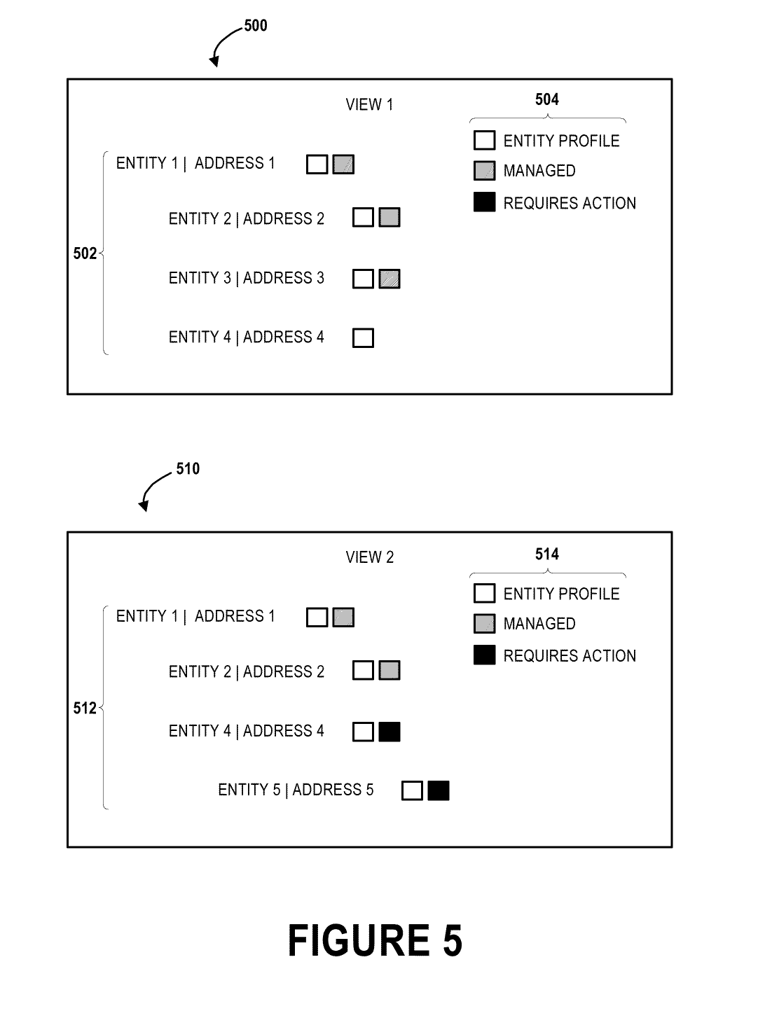

FIG. 1 is an exemplary block diagram illustrating technical components of a system 100 for implementation of the present invention as described in process flows 200, 300, and 400 of FIGS. 2 through 4 respectively, as well as the exemplary interface 500 as illustrated in FIG. 5. As illustrated, the system environment 100 includes a network 110, a system 120, and a user input system 130.

As shown in FIG. 1, the system 120, and the user input system 130 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 is secure and may also include wireless and/or wireline and/or optical interconnection technology.

FIG. 1 also illustrates a system 120, in accordance with an embodiment of the present invention. The system 120 may refer to the “system of the present invention” described herein. The system 120 may include any computerized apparatus that can be configured to perform any one or more of the functions of the system 120 described and/or contemplated herein. In accordance with some embodiments, for example, the system 120 may include a computer network, an engine, a platform, a server, a database system, a front end system, a back end system, a personal computer system, and/or the like. Therefore, the system 120 may be a server managed by the entity. The system 120 may be located at the facility associated with a financial institution (or a third party payment processor) or remotely from the facility associated with the financial institution. In some embodiments, such as the one illustrated in FIG. 1, the system 120 includes a communication interface 122, a processor 124, and a memory 126, which includes a system application 128 and a datastore 129 stored therein. As shown, the communication interface 122 is operatively and selectively connected to the processor 124, which is operatively and selectively connected to the memory 126.

It will be understood that the system application 128 may be configured to implement any one or more portions of the various user interfaces and/or process flow described herein. The system application 128 may interact with the user application 138. It will also be understood that, in some embodiments, the memory includes other applications. It will also be understood that, in some embodiments, the system application 128 is configured to communicate with the datastore 129, the user input system 130, or the like.

It will be further understood that, in some embodiments, the system application 128 includes computer-executable program code portions for instructing the processor 124 to perform any one or more of the functions of the system application 128 described and/or contemplated herein. In some embodiments, the system application 128 may include and/or use one or more network and/or system communication protocols.

In addition to the system application 128, the memory 126 also includes the datastore 129. As used herein, the datastore 129 may be one or more distinct and/or remote datastores. In some embodiments, the datastore 129 is not located within the system and is instead located remotely from the system. In some embodiments, the datastore 129 stores information or data described herein.

It will be understood that the datastore 129 may include any one or more storage devices, including, but not limited to, datastores, databases, and/or any of the other storage devices typically associated with a computer system. It will also be understood that the datastore 129 may store information in any known way, such as, for example, by using one or more computer codes and/or languages, alphanumeric character strings, data sets, figures, tables, charts, links, documents, and/or the like. Further, in some embodiments, the datastore 129 may include information associated with one or more applications, such as, for example, the system application 128. It will also be understood that, in some embodiments, the datastore 129 provides a substantially real-time representation of the information stored therein, so that, for example, when the processor 124 accesses the datastore 129, the information stored therein is current or substantially current.

It will be understood that the embodiment of the system environment illustrated in FIG. 1 is exemplary and that other embodiments may vary. As another example, in some embodiments, the system 120 includes more, less, or different components. As another example, in some embodiments, some or all of the portions of the system environment 100 may be combined into a single portion. Likewise, in some embodiments, some or all of the portions of the system 120 may be separated into two or more distinct portions.

In addition, the various portions of the system environment 100 may be maintained for and/or by the same or separate parties. It will also be understood that the system 120 may include and/or implement any embodiment of the present invention described and/or contemplated herein. For example, in some embodiments, the system 120 is configured to implement any one or more of the embodiments of the process flow 100 described and/or contemplated herein. Additionally, the system 120 and/or the user input system 130 is configured to initiate presentation of any of the user interfaces described herein.

The user input system 130 may include any computerized apparatus that can be configured to perform any one or more of the functions of the user input system 130 described and/or contemplated herein. For example, a user 135 may use the user input system 130 (e.g., a mobile device) to transmit and/or receive information or commands to and from the system 120. In some embodiments, for example, the user input system 130 may include a personal computer system (e.g. a non-mobile or non-portable computing system, or the like), a mobile computing device, a personal digital assistant, a mobile phone, a tablet computing device, a network device, a wearable computing device, a sensor, and/or the like. As illustrated in FIG. 1, in accordance with some embodiments of the present invention, the user input system 130 includes a communication interface 132, a processor 134, a memory 136 having a user application 138 stored therein, and a user interface 139. In such embodiments, the communication interface 132 is operatively and selectively connected to the processor 134, which is operatively and selectively connected to the user interface 139 and the memory 136. In some embodiments, the user 135 may use the user application 138 to execute processes described with respect to the process flows and interfaces described herein. Specifically, the user application 138 executes the process flows described in FIGS. 2 through 4.

Each communication interface described herein, including the communication interface 132, generally includes hardware, and, in some instances, software, that enables the user input system 130, to transport, send, receive, and/or otherwise communicate information to and/or from the communication interface of one or more other systems on the network 110. For example, the communication interface 132 of the user input system 130 may include a wireless transceiver, modem, server, electrical connection, and/or other electronic device that operatively connects the user input system 130 to another system such as the system 120. The wireless transceiver may include a radio circuit to enable wireless transmission and reception of information. Each processor described herein, including the processor 134, generally includes circuitry for implementing the audio, visual, and/or logic functions of the user input system 130. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 138 of the memory 136 of the user input system 130.

Each memory device described herein, including the memory 136 for storing the user application 138 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 1, the memory 136 includes the user application 138. In some embodiments, the user application 138 includes an interface for communicating with, navigating, controlling, configuring, and/or using the user input system 130. In some embodiments, the user application 138 includes computer-executable program code portions for instructing the processor 134 to perform one or more of the functions of the user application 138 described and/or contemplated herein. In some embodiments, the user application 138 may include and/or use one or more network and/or system communication protocols.

Also shown in FIG. 1 is the user interface 139. In some embodiments, the user interface 139 includes one or more output devices, such as a display and/or speaker, for presenting information to the user 135. In some embodiments, the user interface 139 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 135. In some embodiments, the user interface 139 includes the input and display devices of a mobile device, which are operable to receive and display information.

Also shown in FIG. 1 is the user 135 of the user input system 130. The user input system 130 may be any computing device. The user 135 may be a person who uses the user input system 130 to execute a user application 138. The user application 138 may be an application to communicate with the system 120, perform a transaction, input information onto a user interface presented on the user input system 130, receive and/or transmit information, the like. The user application 138 and/or the system application 128 may incorporate one or more parts of any process flow described herein.

The system environment 100 may further include various other systems that are configured and/or enabled to communicate with the system 120 and/or user system 130 via the network 110. In this way, information may be transmitted to and/or received from various systems associated with different entities. For example, the system 120 may receive information from a third party. The received information may be processed by the processor 124 and/or stored in the memory 126 of the system 120. Alternatively, the received information may be transmitted to and/or received by the user input system 130 and therefore processed by the processor 134 and/or stored in the memory 136 of the user input system 130. In this way, the system in configured to seamlessly share information between various systems and elements of the system environment 100. The system environment 100 may be in real time communication with a large repository of financial information, account information, transactional information. contact information, and/or the like of a financial institution.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

In some embodiments, the term “entity” refers to any type of business entity. For example, an entity may refer to a company, a business, a vendor, a merchant, a customer, a contractor and/or subcontractor, a brand, and/or the like. Alternatively, an entity may refer to a subsidiary of a company (e.g., a child company), an overarching company (e.g., a parent company), a holdings company, and/or the like. Alternatively, an entity may refer to a financial institution, a third party payment processing company, a law firm, an investment bank, and/or the like.

In some embodiments, the term “entity data” refers to any type of data and/or information associated with (e.g., corresponding to, of, and/or the like) an entity. Entity data may include company information (e.g., a company name, an incorporation date, an incorporation location, an employee name, an owner name, and/or the like), contact information (e.g., a phone number, an address, and/or the like), account information (e.g., an account number, a routing number, a card number, an expiration date, a security code, an account alias, an account token, and/or the like), and/or the like of an entity.

In some embodiments, entity data may be generated and/or stored by the system 120. Also, the user 135 (e.g., an administrator, an associate, and/or an agent of the financial institution) may manually input entity data into the system environment 100 using the user input system 130. Alternatively and/or in combination with the aforementioned means of entity data generation, the system 120 may also receive entity data from one or more other systems associated with other entities using the network 110. For example, entity data may be received by the system 120 directly from an entity (e.g., a vendor, a merchant, and/or the like), a third party payment processing company, and/or the like. Entity data may be transmitted from a variety of sources to the system 120 in a constant real time stream of information or at predetermined intervals of time.

In some embodiments, the system 120 may receive one or more files such as workbooks, spreadsheet, text files, strings of binary digits, and/or the like that contains entity data. Upon receipt of the files by the system 120, the entity data is extracted from the received files by the system 120 for processing. The files of entity data and/or raw entity data (e.g., entity data not held in a file) may be a product of Accounts Payable, Sourcing, M&A activity, a completed transaction, and/or another financial procedure.

Next, the system 120 aggregates the received and/or extracted entity data, thereby consolidating entity data from various sources into one central location. In doing so, the system 120 validates entity data received from various sources to ensure that all of the consolidated entity data is secure, complete, and/or formatted similarly. Typically, validating entity data includes converting the format of entity data from a first data format into a second, standardized data format (e.g., normalized entity data) to bring all entity data into a consistent format.

Validating entity data may further include transmitting the entity data to a third party data validator for validation. In this way, a third party validator may determine a confidence score for how accurate and/or true the entity data is. For example, a third party validator may utilize a scale from 1 to 10, where 1 is inaccurate and 10 is accurate. The third party validator then determines that entity data is an 8, and therefore is automatically validated and accepted as validated by the system 120. Alternatively, entity data that receives a 5 may require review by the user 135, while entity data that receives a 2 is automatically rejected as being inaccurate. Therefore, threshold values of confidence scores may be used by the system 120 and/or a third party validator to assess whether or not entity data should be validated.

Validating entity data may further include determining that entity data is complete or incomplete. In response to determining that entity data is incomplete, the system 120 may request additional information and/or entity data from the appropriate source (e.g., the entity, the vendor, the user 135, and/or the like) to ensure that the received entity data is complete and/or valid.

The system 120 then stores the validated entity data in the memory 124. Alternatively, the validated entity data may be stored in another memory location (e.g., the memory 134, on a cloud server, and/or the like) or transmitted to another system for third party processing. The validated entity data may be accessed, viewed, modified, added, and/or deleted by the user 135 or another user. The validated entity data may also be transmitted by the system 120 to another system (e.g., the user input system 130, a third party processor, and/or the like) for processing.

The system 120 utilizes the validated entity data to generate an entity profile for each entity. An entity profile is a collection or aggregation of entity data of an entity that may be viewed by the user 135 for analysis of the entity. Entity profiles are generated based on how entity data of each entity adheres to a plurality of predetermined attributes. These attributes are predetermined business rules, characteristics, qualities, controls, and/or points of measure for categorizing the entity data of each entity. For example, attributes may include a company type, particular factors for evaluating an entity's monetary value, cash flow statements, an amount of debt, active and/or potential new lines of business, and/or other aspects of a company. The attributes may be financially focused, personnel focused, risk focused, legally focused, and/or the like. In this way, the validated entity data of an entity is analyzed by the system 120 according to the attributes.

In some embodiments, the attributes may be defined, added, deleted, and/or modified by the user 135 or another user (e.g., an administrator of the financial institution, or the like) using the user input system 130, or in accordance with instructions received from another system (e.g., a central attribute control system, for example). Typically, attributes are defined and/or evaluated by the user 135 or another user (e.g., a financial institution control analyst) at a contractual level (e.g., when a transaction is being negotiated or before the actual transaction takes place). This enables the attributes to set a precedent for similar future transactions.

The system 120 generates and/or receives a constant real time stream of updated attributes from other systems. In some embodiments, the system 120 may generate and/or receive a constant real time stream of updated attributes from systems internal and/or external to the enterprise. In this regard, the system 120 may receive a constant real time stream of updated attributes from primary sources internal to the enterprise such as sales, purchase orders, transactions in inventory, or the like. In addition, the system 120 may receive a constant real time stream of updated attributes from secondary sources external to the enterprise such as information collected by commercial market organizations, the government, competitors, trade publications, and the general media (e.g., news). A constant stream of updated attributes enables the financial institution to more accurately define particular characteristics of entities that are important and/or critical to the financial institution's understanding of each entity. In this way, the financial institution is better enabled to control how it views, understands, and interacts with each entity. The system 120 also enables the user 135 or another user to add, delete, and/or modify the entity profile of an entity.

When an entity becomes a new customer of a financial institution, entity data of the entity is to be onboarded (e.g., added to a customer database of a financial institution). As such, the system 120 receives entity data of the entity from one or more sources. In this regard, the system 120 may be configured to triangulate the data through cross-verification from two or more sources. In this way, the entity data of the entity from one or more sources may be deemed credible by minimizing inadequacies found in one-source data when multiple sources confirm the same data. For example, the user 135 may manually input a company name and company address. The received entity data of the entity is validated by the system 120 to ensure that the received entity data is compatible with the system 120, thereby resulting in validated entity data.

Before a new entity profile is generated for the entity using the validated entity data, the system 120 is configured to compare the validated entity data to existing entity data stored in the memory 124 (or another memory location, such as a database of entity profile data stored by the financial institution). The existing entity data to which the validated entity data is compared typically corresponds to entities that are existing customers of the financial institution. Alternatively, the existing entity data to which the validated entity data is compared may correspond to entities that are not existing customers of the financial institution, but entities that are indeed known to the financial institution and therefore have records of entity data.

In some embodiments, the system 120 determines, based on comparing the validated entity data of the entity to be added to existing entity data of entities known to the financial institution, that there is no match between the validated entity data of the entity to be added and existing entity data of entities known to the financial institution. Therefore, the system 120 may prompt the user 135 to create a new entity profile of the entity to be added based on the validated entity data. The system 120 may then generate an entity profile for the entity based on received inputs from the user 135.

In other embodiments, the system 120 determines, based on comparing the validated entity data of the entity to be added to existing entity data of entities known to the financial institution, a complete match between the validated entity data of the entity to be added and existing entity data of entities known to the financial institution. Therefore, the system 120 may prompt the user 135 with a notification (e.g., an alert, or the like) that the entity to be added is indeed determined to be a duplicate entity entry. The system 120, upon receiving user confirmation of the determined duplication, may discard or erase the validated entity data.

Alternatively, the system 120 determines, based on comparing the validated entity data of the entity to be added to existing entity data of entities known to the financial institution, a partial match between the validated entity data of the entity to be added and existing entity data of entities known to the financial institution. Therefore, in response to determining a partial match, the system 120 determines that the entity to be added is related to an entity known to the financial institution.

The system 120 then aligns the validated entity data of the entity to be added with entity data of an entity known to the financial institution. For example, the system 120 may store the validated entity data of the entity to be added in the same storage location as where entity data of the entity known to the financial institution is stored. The system 120 may also utilize some or all of the validated entity data to update the entity profile of the entity known to the financial institution. Further, the system 120 may generate an entity profile of the entity to be added using the validated entity data and/or some or all of the entity data of the entity known to the financial institution. The system 120 may also link (e.g., associate, provide a pointer to, and/or the like) the generated entity profile of the entity to be added and the entity profile of the entity known to the financial institution.

In this way, when the user 135 recalls one of the entity profiles (e.g., either the entity profile of the entity to be added or the entity profile of the entity known to the entity) for viewing, the other entity profile is also recalled for viewing. This enables the user 135 to more quickly view multiple entity profiles and enables the user 135 to better understand how entities are related. For example, if the user 135 requests to view Entity A, which is determined to be related to Entity B, then the system 120 (or the user input system 130) recalls both the entity profile of Entity A and the entity profile of Entity B for presentation to the user 135.

The system 120 is further enabled to determine which type of relationship exists between two entities (e.g., the entity to be added and the entity known to the financial institution). Through an analysis of entity data (e.g., the validated entity data and the entity data of the entity known to the financial institution), the system 120 can determine exactly how two entities are related. For example, if Entity A and Entity B are determined to be related, and Entity A has an address of Location A while Entity B has an address of Location B, and the financial institution knows that Location A is the headquarters location of these related companies, then the system 120 may determine that Entity A is a parent company of Entity B and/or that Entity B is a subsidiary of Entity A. The system 120 may analyze one or more of entity data, account information, contact information, company information, transaction information, and/or the like to make relationship type determinations.

In some embodiments, the system 120 calculates a confidence score of how likely it is that two entities are related. For example, if entity data of Entity A partially matches entity data of Entity B, the system 120 calculates a confidence score based on how much the entity data of Entity A matches the entity data of Entity B, which pieces of entity data of Entity A match which pieces of entity data of Entity B, and/or the like.

In some embodiments, the system 120 requires user confirmation for the alignment of two entities. Therefore, the system 120 may request from the user 135 user confirmation that two entities are to be aligned by prompting the user 135. Upon receipt of user confirmation from the user input system 130, the system 120 may align the two entities. In other embodiments, no user confirmation is required by the system 120 for alignment of entities. Instead, entities may be automatically aligned with each other based on determining a match or at request of the user 135 (or another user). For example, the system 120 may be configured to process existing entity data (e.g., compare existing entity data to other existing entity data) to determine relationships between entities that are already known to the entity.

The system 120 is further configured to generate a report of entity alignments. For example, the system 120 may generate a notification, an alert, an email, a message, and/or the like that includes a history of entity data comparisons, a summary of related entities, a list of attributes used in generating an entity profile of an entity, a timestamp, and/or the like. This generated notification may be transmitted to the user 135 and/or saved in memory 124 by the system 120.

Once two entities have been aligned, the system 120 is further configured to enable the user 135 to view an entity profile of one or more entities in a variety of manners. In response to one or more requests from the user 135, the system 120 generates views of entity profiles that are related. The user 135 is enabled to switch seamlessly between different views.

Typically, the user 135 is enabled to view entity profiles based on which attributes are of present interest to the user 135. The attributes essentially filter undesired entity data from the view of the entity profile. This ensures that only entity data that is relevant to the user's 135 request of a desired view is included in the entity profile view. In one aspect, the system 120 may be configured to display a set of default attributes (e.g., M&A updates) common to each of the one or more entity profiles generated.

For example, the user 135 may be interested in viewing a Legal hierarchy (e.g., a corporate structure) of an entity and its related entities (e.g., how each entity is legally connected based on registration with the Secretary of State or other a governing body). In this way, the user 135 (e.g., an associate of the financial institution) may better understand which entities are parent companies, children companies, subsidiaries, holding companies, partners, vendors, contractors, customers, and/or the like.

The system 120 therefore presents to the user 135 a view of one or more entity profiles (e.g., one for each related entity). The presented entity profiles typically only include the entity data that is relevant to the desired view. This set of entity data is determined by the system 120 based on which attributes are deemed relevant for producing each particular view type. For example, a company name and location of incorporation of an entity may be included in a Legal view, whereas all presently-open lines of business between an entity and a financial institution may not be included in a Legal view.

The system 120 may also generate a Manage view for viewing by the user 135. The Manage view may display contacts of an entity that deal with the financial institution. In this way, the financial institution can more appropriately manage its existing relationships with each entity. The Manage view also increases awareness of lines of business between the financial institution and each entity and the people who are in charge of giving those lines of business.

Alternatively, the user 135 is enabled to view an Engage hierarchy of an entity and its related entities. An Engage view enables the user 135 to see how the financial institution engages each entity in a related family of entities in various lines of business or services. For example, the Engage view may display all of the channels by which the financial institution collects revenue from each entity such as bank accounts, credit lines, loans, and/or the like.

Furthermore, the Engage view may enable the financial institution to identify new potential lines of business between the financial institution and each entity in the Manage view. In some embodiments, the system 120 is configured to identify new lines of business (e.g., channels by which the financial institution may engage an entity) based on an analysis of entity data and/or attributes. The system 120 may then provide a recommendation report to the user 135 of new ways to engage an entity. The recommendation may be in the form of an email, a message, a notification, an alert, and/or the like. For example, if Entity A is a parent company of Entity B, and Entity A has a financial investment account with a financial institution while Entity B does not, then the system may recommend to the financial institution to reach out and engage Entity B in conversations regarding opening a financial investment account with the financial institution.

Additionally, the user 135 is enabled to view a Spend hierarchy of an entity and its related entities. A Spend view enables the user 135 to see amounts of money that are transacted between the financial institution and each entity in the Spend view, as well as through which channels the amounts of money are transacted.

In other embodiments, the user 135 is enabled to view a Risk hierarchy of an entity and its related entities. A Risk view enables the user 135 to see how much and which types of risk is associated with each entity. The system 120 is configured to determine a risk level and/or risk type associated with each entity in the Risk view. The risk level and risk type of each entity is determined based on an analysis of entity data and/or attributes. Furthermore, the system 120 may utilize the determined relationship between entities in determining a risk level and/or risk type. For example, if a financial institution is evaluating risk associated with engaging Entity A for a new line of business and Entity A is a child company of Entity B, then the financial institution will know to compensate for additional risks when engaging with Entity A due to Entity B's parent status. The system 120 may prompt the user 135 with a notification, an alert, and/or the like regarding the risk level and risk type of each entity in the Risk view.

Other types of views are also configured to be generated by the system 120 and presented to the user 135. The user 135 may be enabled to add, delete, modify, and/or configure various views and/or view types so that the user 135 can customize a view based on a particular set of attributes. Each view may be selected by the user 135 from a central hub and/or dashboard interface of the user input system 130 or another system (e.g., a mobile workstation of a financial institution associate).

In some embodiments, the system 120 is configured to save a snapshot of each generated view. For example, the system 120 may save a snapshot of each view at predetermined intervals (e.g., daily). This creates a record of each view so that the financial institution can recall an entity's entity profile at any given point in its history.

In some embodiments, streams of updated entity data and updated attributes are received by the system 120 at predetermined intervals of time or in real time. In other embodiments, updated entity data and updated attributes are received by the system 120 based on (e.g., as a result of) M&A activity, a transaction, a purchase, a buyout, a sell, and/or the like. As such, the system 120 is configured to automatically update its records of entity data and attributes. Views of entity profiles are generated by the system 120 according to updated attributes and are therefore presented to the user 135 with updated entity data. This real time updating of entity profiles is particularly useful because it eliminates the need for the user 135 or another user to manually check for updated entity data and/or attributes and ensures that each view of an entity profile is accurate and up to date. For example, a Legal view of Entity A may update automatically based on a recent acquisition of Entity A by Entity B. Entity B will then appear as a parent of Entity A. Therefore, as entity data and attributes are updated by the system 120, the views that are generated by the system 120 are updated. This may occur in real time as updated entity data and attributes are received by the system 120, or at predetermined intervals of time.

Furthermore, the system 120 is configured to identify the impact of changes (e.g., updates) to entity data, attributes, and, therefore, entity profiles. Identifying the impact of changes to entity data and attributes makes the user 135 aware of how each entity profile will be affected. For example, a change in entity data of Entity A, which is related to Entity B, may cause entity data (and therefore the entity profile) of Entity B to be affected. This identification of the system 120 enables the user 135 to become aware of each “downstream” impact due to changes in entity data and/or attributes. Changes in entity data and/or attributes may affect different views of the same entity (or different but related entities) as well.

Changes in entity data and/or attributes may cause various actions to be performed by the financial institution or the system 120. For example, if the entity profile of Entity A is updated based on a recent acquisition, then the financial institution will be required to process various paperwork, establish new contacts and lines of business with Entity A and any related entities. Therefore, the system 120 may recommend one or more actions to the user 135, and/or the financial institution so that the appropriate procedures take place in response to identification of impacts based on changes in entity data and/or attributes.

In some embodiments, the system 120 requires user approval for each change in entity profiles, as well as any actions to be performed by the system 120 or the financial institution, based on changes in entity data and/or attributes. Therefore the system 120 prompts the user 135 for user approval, which is submitted by the user 135 using the user input system 130 and transmitted to the system 120. Upon receipt of user approval, the system 120 then updates all entity profiles with updated information. In other embodiments, the system 120 automatically makes all changes without requiring user approval.

Additionally, the system 120 may generate a report that summarizes all changes to entity data, attributes, and/or entity profiles. The system 120 transmits the report to the user 135 for review. In this way, the report, typically an email, notification, alert, message, and/or the like, may be reviewed by the user 135 prior to, substantially simultaneously to, and/or after changes in entity data are identified and/or made by the system 120. Essentially, this report may serve as a layer of control so that the user 135 is aware of all changes in entity data and/or attributes, as well as how those changes impact various downstream processes of the financial institution.

Lastly, the system 120 makes available the stores of entity data in the memory 124 to various other systems and users of the financial institution. Because the system 120 is responsible for aggregating and normalizing entity data, as well as ensuring that the entity data is up to date, the system 120 serves as an excellent source of information (e.g., entity data) that can be utilized across a plurality of departments of the financial institutions and third party data processors.

FIG. 2 illustrates an exemplary process flow illustrating a process flow 200 for identifying a relationship between two entities based on an analysis of entity data. At block 210, the process includes receiving first entity data of a first entity from a network of distributed servers. At block 220, the process includes comparing the first entity data to entity data of a plurality of other entities, wherein the entity data of the plurality of other entities is stored in a database. At block 230, the process includes identifying, based on comparing the first entity data to entity data of the plurality of other entities, at least a partial match between the first entity data and entity data of the plurality of other entities. At block 240, the process includes determining, based on identifying at least a partial match between the first entity data and entity data of the plurality of other entities, that the first entity is related to a second entity, wherein the second entity is one of the plurality of other entities.

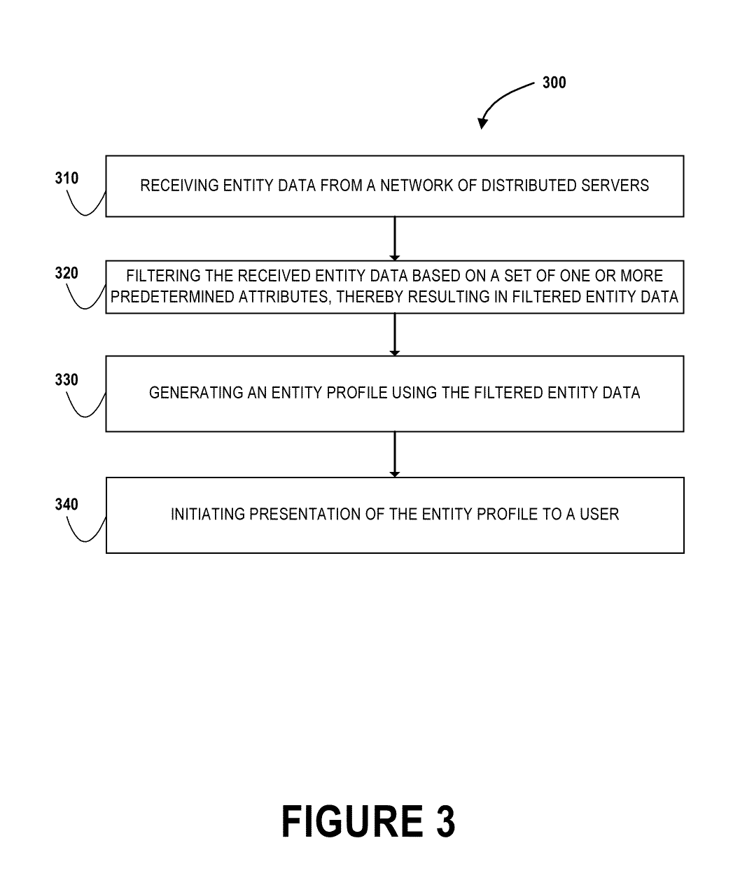

FIG. 3 illustrates an exemplary process flow diagram illustrating a process flow 300 for hierarchically viewing an entity profile. At block 310, the process includes receiving entity data of an entity from a network of distributed servers. At block 320, the process includes filtering the received entity data based on a set of one or more predetermined attributes, thereby resulting in filtered entity data. At block 330, the process includes generating, by a computing device processor, an entity profile using the filtered entity data. At block 340, the process includes initiating, by a computing device processor, presentation of the entity profile to a user.

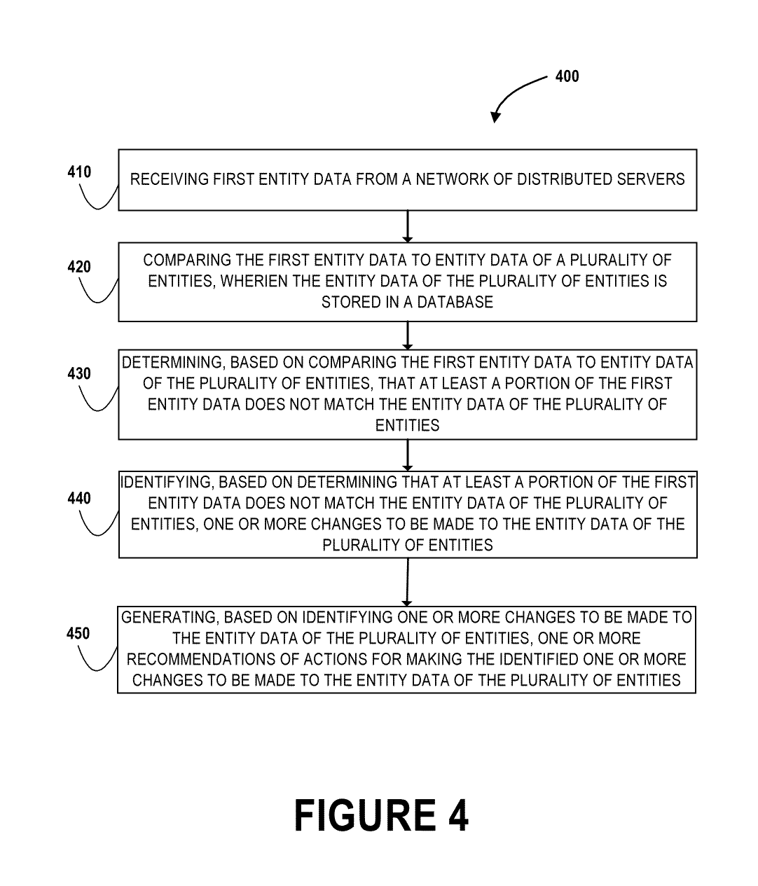

FIG. 4 illustrates an exemplary process flow diagram illustrating a process flow 400 for identifying impacts based on changes in entity data. At block 410, the process includes receiving first entity data from a network of distributed servers. At block 420, the process includes comparing the first entity data to entity data of a plurality of entities, wherein the entity data of the plurality of entities is stored in a database. At block 430, the process includes determining, based on comparing the first entity data to entity data of the plurality of entities, that at least a portion of the first entity data does not match the entity data of the plurality of entities. At block 440, the process includes identifying, based on determining that at least a portion of the first entity data does not match the entity data of the plurality of entities, one or more changes to be made to the entity data of the plurality of entities. At block 450, the process includes generating, based on identifying one or more changes to be made to the entity data of the plurality of entities, one or more recommendations of actions for making the identified one or more changes to be made to the entity data of the plurality of entities.

FIG. 5 illustrates exemplary user interfaces 500, 510 for two system-generated views. Each of the interfaces 500, 512 depict a Legal view outlining a corporate structure 502, 512 of Entity 1. Legends 504, 514 enable the user 135 to easily understand icons that may be adjacent to each entity. The icons adjacent to each entity in the corporate structures 502, 512 may denote, among other things, which entities have an entity profile that is registered with the financial institution, which entities are actively managed by (e.g., have an existing business relationship with) the financial institution, and which entities have potential actions to be taken as recommended by the system 120.

The interface 500 depicts a View 1 of Entity 1 as a parent company of Entities 2, 3, and 4. Entities 2 and 3 are managed by the financial institution, while Entity 4 is not managed by the financial institution. View 1 is generated by the system 120 based on a particular set of predetermined attributes.

The interface 510 represents an updated View 2 of Entity 1 being a parent company of Entities 2 and 4; Entity 3, however, has been corporately restructured as a subsidiary of Entity 4. In this way, and assuming View 2 is generated based on the same particular set of predetermined attributes as View 2, the system 120 has determined that Entity 3 and its associated entity data is no longer relevant to View 2 and is therefore not to be included in the interface 510. Additionally, entity data associated with the new Entity 5 is received, validated, and stored by the system 120.

In View 2, Entity 2 remains managed by the financial institution, while Entity 4 remains unmanaged by the financial institution. Because Entity 4 is not managed by the financial institution (as denoted by the icons adjacent to Entity 4), the system 120 identifies an opportunity to engage Entity 4 in at least one line of business. Further, because an opportunity has been identified with Entity 4, the system 120 also presents an opportunity icon next to Entity 5, the newly-added subsidiary of Entity 4. In this way, the system 120 alerts the user 135 that review of the relationship between the financial institution and Entity 5 may be required.

In the interfaces 500, 510 the user 135 may select each entity name in the corporate structures 502, 512 to view each entity's entity profile. Selecting the Managed icon next to each entity may present to the user 135 a listing of contacts of each entity, the channels through which the financial institution engages each entity, and/or other entity data. In this manner, the user 135 may select other views. The system 120 also may present a report to the user 135 upon selection of the Requires Action icons. In this way, the user 135 may review the recommendations of the system 120 to address various impacts of changes in entity data and/or attributes.

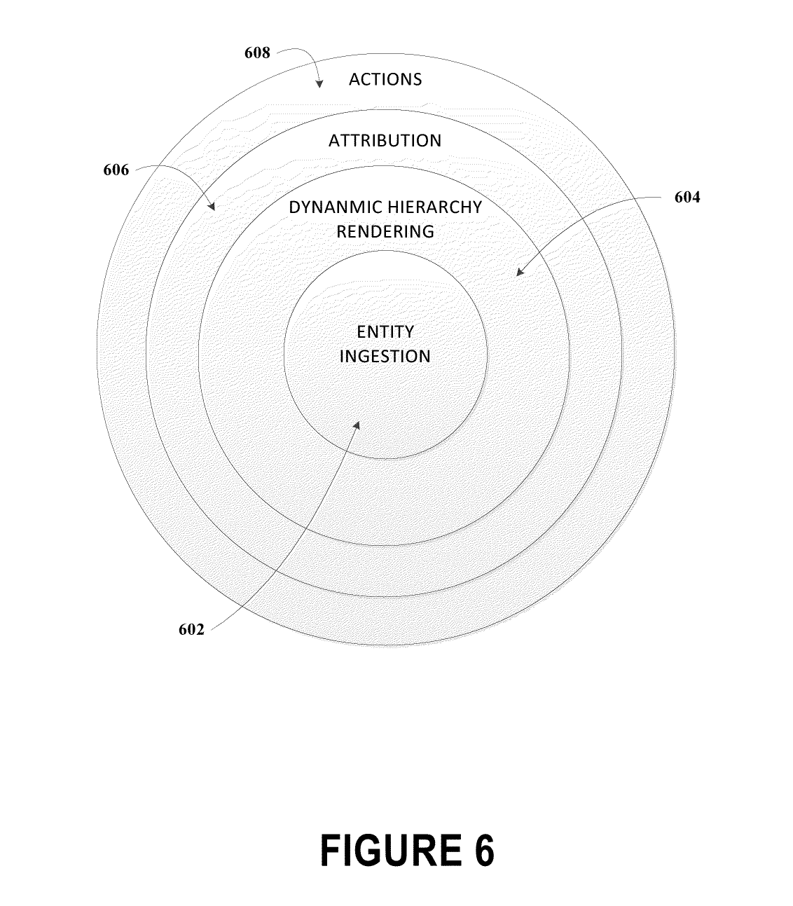

FIG. 6 illustrates a representation of the target state of the framework, in accordance with an embodiment of the invention 600. As shown in the figure, the target state of the framework includes entity ingestion 602, dynamic hierarchy rendering 604, attribution 606, and actions 606. In some embodiments, the entity ingestion 602 of the target framework receives entity data including attributes from one or more external entities across multiple bank systems and vendor attributes from one or more bank users in various up-stream solutions. In response to ingestion of the entity data and/or entity attributes, the inbound data is collected and prepared for validation. The inbound data may be validated using internal validation techniques or a third process validation as described herein. In response, the system 120 may be configured to provide initial external data enrichment in real-time or substantially real-time and render dynamic hierarchy in the dynamic hierarchy rendering 604 aspect of the target framework. In one aspect, the hierarchies may include legal hierarchies and bank defined hierarchies.

The attribution 606 of the target framework may be configured to monitor and capture hierarchy changes and communicate the captured changes to trigger one or more actions corresponding to the changes captured using the actions 606 of the target framework.

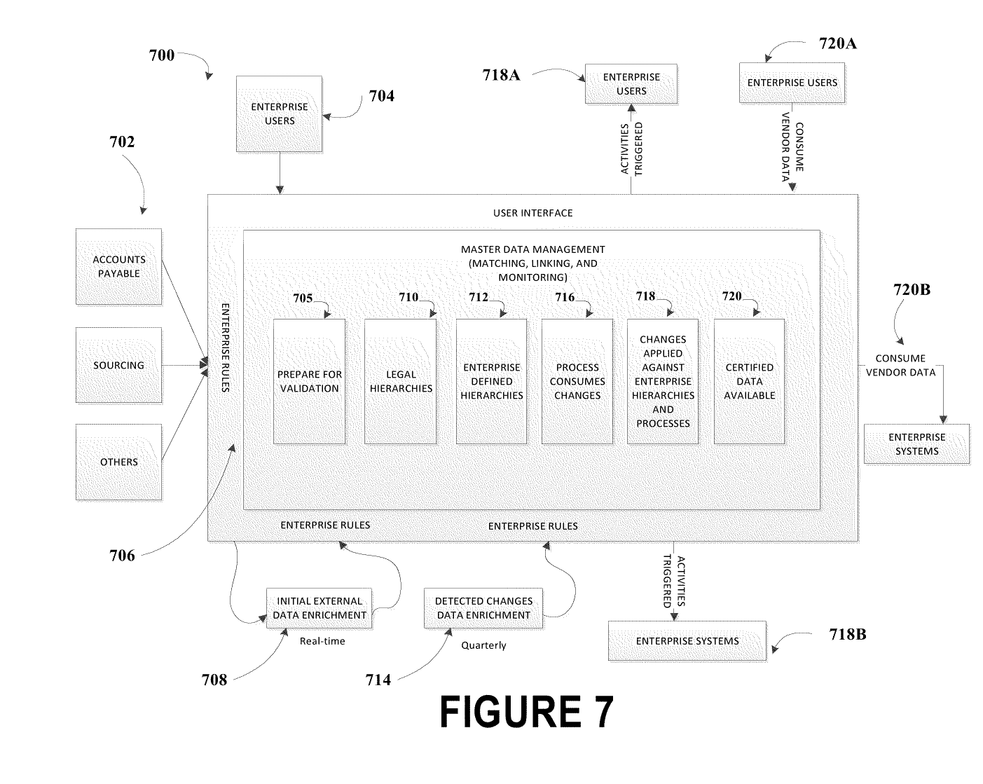

FIG. 7 illustrates an exemplary a high level process flow for master data management based on the target state of the framework, in accordance with an embodiment of the invention 700. As shown, the process flow for master data management includes receiving one or more attributes (e.g. accounts payable, sourcing, or the like) from one or more external entities across multiple enterprise systems 702. In one aspect, the one or more attributes may include but are not limited to core entity attributes (e.g. name, address, location, or the like), extended entity attributes, engagement specific attributes detailing “how” the entity is engaged with the enterprise, extended engagement attributes, or the like. In some embodiments, the extended attributes associated with the entity and/or the entity engagement with the enterprise may include additional information required to detail the entity's association with the enterprise to enable better comparison for purposes of matching. In some embodiments, the process flow may include receiving one or more attributes associated with the entity from one or more enterprise users 704 in various up-stream solutions singularly, or in bulk.

In response to receiving one or more attributes, the process flow includes preparing the received attributes for validation 705. In this regard, the attributes may be prepared for validation by comparing one or more business rules 706 with pre-existing data. In response, the process flow includes validating the received attributes and identifies one or more unique aspects from the attributes received. In one aspect, identifying unique attributes includes enriching the received attributes with auxiliary data in real time as indicated in block 708. In this regard, the auxiliary data may be include internal data received from one or more operations associated with the enterprise and/or external data received from sources such as M&A activity, a transaction, a purchase, a buyout, a sell, and/or the like external to the enterprise. In response to validating the one or more received entities, the system 120 returns a legal hierarchical structure 710 of related entities.

In response, the process flow overlays the hierarchies defined by the enterprise 712 on the legal hierarchical structure. In one aspect, the enterprise defined hierarchies 712 may be based on spend, managed, geography, line of business, or the like. In some embodiments, the hierarchical structure may include information associated with commonly-owned company, a parent company, a child company, a vendor, a merchant, a customer, a contractor, a subsidiary of the enterprise, or the like. In response, the process flow includes external monitoring to detect changes 714 associated with the legal entity to be delivered to the solution. In one aspect, the captured changes are enriched with additional information to enhance the data prior to being delivered to the solution.

In response, the process flow enables the enterprise to consume the changes 716 and absorb the corresponding impact. In this regard, the system 120 may be configured to apply the changes against the enterprise hierarchies and processes as shown in 718. In some embodiments, the system 120 may be configured to execute manual and/or automatic triggers to enable one or more impacted tools, personnel, and/or processes to accept the detected changes and adapt accordingly. In one aspect, the detected changes may include changes to risk requirements, contracting requirements, relationship requirements, spend analytics, and/or one or more regulatory impacts (e.g. cross-border data, foreign asset control, diversity, or the like). In another aspect, the one or more triggers may be associated with enterprise users 718A and/or enterprise systems 718B.

In response to absorbing and adapting to the detected changes, the process flow includes providing certified, accurate, and timely customer data as shown in block 720 to enterprise users 720A and/or enterprise systems 720B.

Although embodiments of the present invention described herein are generally described as involving a customer, it will be understood that customers may involve one or more persons, organizations, businesses, institutions, vendors, third parties and/or other entities such as financial institutions, services providers etc. that implement one or more portions of one or more of the embodiments described and/or contemplated herein.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for electronically viewing an entity profile based on one or more attributes, the system comprising:
at least one non-transitory electronic storage device;
at least one processor; and
at least one module stored in said storage device and comprising instruction code that is executable by the at least one processor and configured to cause said at least one processor to:
receive entity data of an entity from a network of distributed servers;
filter the received entity data based on a set of one or more predetermined attributes, thereby resulting in filtered entity data;
generate an entity profile using the filtered entity data; and
initiate presentation of the entity profile to a user.

2. The system of claim 1, wherein the set of one or more predetermined attributes are business rules associated with at least one of a Legal, Exposure, Engage, Manage, and Spend hierarchal view.

3. The system of claim 1, wherein the module is further configured to cause a processor to:
receive at least one of updated entity data and one or more updated predetermined attributes;
update the generated entity profile in real time using at least one of the updated entity data and one or more updated predetermined attributes, thereby generating an updated entity profile; and
initiate presentation of the undated entity profile to the user.

4. The system of claim 1, wherein the entity profile comprises entity data of at least one other entity that is related to the entity.

5. The system of claim 1, wherein the module is further configured to cause a processor to:
receive a request from a user to view an entity profile; and
generate the entity profile in response to receiving the request.

6. The system of claim 1, wherein the module is further configured to cause a processor to:
generate a report of the entity profile, wherein the report comprises at least one of a message, a notification, an email, and an alert; and
transmit the report to the user.

7. The system of claim 1, wherein entity data comprises at least one of account information, contact information, and company information.

8. A computer program product for electronically viewing an entity profile based on one or more attributes, the computer program product comprising a non-transitory computer-readable medium comprising instruction code configured to cause an apparatus to:
receive entity data of an entity from a network of distributed servers;
filter the received entity data based on a set of one or more predetermined attributes, thereby resulting in filtered entity data;
generate an entity profile using the filtered entity data; and
initiate presentation of the entity profile to a user.

9. The computer program product of claim 8, wherein the set of one or more predetermined attributes are business rules associated with at least one of a Legal, Exposure, Engage, Manage, and Spend hierarchal view.

10. The computer program product of claim 8, wherein the non-transitory computer-readable medium comprises instruction code configured to cause an apparatus to:
receive at least one of updated entity data and one or more updated predetermined attributes;
update the generated entity profile in real time using at least one of the updated entity data and one or more updated predetermined attributes, thereby generating an updated entity profile; and
initiate presentation of the undated entity profile to the user.

11. The computer program product of claim 8, wherein the entity profile comprises entity data of at least one other entity that is related to the entity.

12. The computer program product of claim 8, wherein the non-transitory computer-readable medium comprises instruction code configured to cause an apparatus to:
receive a request from a user to view an entity profile; and
generate the entity profile in response to receiving the request.

13. The computer program product of claim 8, wherein the non-transitory computer-readable medium comprises instruction code configured to cause an apparatus to:
generate a report of the entity profile, wherein the report comprises at least one of a message, a notification, an email, and an alert; and
transmit the report to the user.

14. The computer program product of claim 8, wherein entity data comprises at least one of account information, contact information, and company information.

15. A computer implemented method for electronically determining that a relationship exists between two entities, the method comprising:
receiving, by a computing device processor, entity data of an entity from a network of distributed servers;
filtering, by a computing device processor, the received entity data based on a set of one or more predetermined attributes, thereby resulting in filtered entity data;
generating, by a computing device processor, an entity profile using the filtered entity data; and
initiating, by a computing device processor, presentation of the entity profile to a user.

16. The method of claim 15, wherein the set of one or more predetermined attributes are business rules associated with at least one of a Legal, Exposure, Engage, Manage, and Spend hierarchal view.

17. The method of claim 15, wherein the method further comprises:
receiving, by a computing device processor, at least one of updated entity data and one or more updated predetermined attributes;
updating, by a computing device processor, the generated entity profile in real time using at least one of the updated entity data and one or more updated predetermined attributes, thereby generating an updated entity profile; and
initiating, by a computing device processor, presentation of the undated entity profile to the user.

18. The method of claim 15, wherein the entity profile comprises entity data of at least one other entity that is related to the entity.

19. The method of claim 15, wherein the method further comprises:
receiving, by a computing device processor, a request from a user to view an entity profile; and
generating, by a computing device processor, the entity profile in response to receiving the request.

20. The method of claim 15, wherein the method further comprises:
generating, by a computing device processor, a report of the entity profile, wherein the report comprises at least one of a message, a notification, an email, and an alert; and
transmitting, by a computing device processor, the report to the user.
